(19) United States
(12) Patent Application Publication
(10) Pub. No.: US 2007/0225943 A1
(43) Pub. Date: Sep. 27, 2007

(54) Executable application operation monitoring system

(76) Inventor: Howard T. Marano, Malvern, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/293,929

(22) Filed: Dec. 5, 2005

Related U.S. Application Data
(60) Provisional application No. 60/633,474, filed on Dec. 6, 2004.

(51) Int. Cl. G06F 19/00

(52) U.S. Cl. 702/186; 702/108; 702/127; 702/182

(57) ABSTRACT

A system traces operation of a multi-threaded executable application having concurrently operating code portions. An input processor receives data representing one or more data items being processed by an executable procedure. A filter processor determines whether the received data matches predetermined configuration parameters. A trace processor initiates generation of data tracing execution of instructions, comprising the executable procedure, in response to the received data matching the predetermined configuration parameters. The trace processor inhibits generation of the tracing data in response to the received data failing to match the predetermined configuration parameters.

### CROSS-REFERENCE TO RELATED APPLICATIONS

The present application is a non-provisional application of provisional application having Ser. No. 60/633,474 filed by Howard T. Marano on Dec. 6, 2004.

### FIELD OF THE INVENTION

The present invention generally relates to computer systems. More particularly, the present invention relates to a computer system having an executable application operation monitoring system.

### BACKGROUND OF THE INVENTION

A computer system is a device for processing information according to a software program, otherwise called a computer application, which is a compiled list of instructions. Sometimes, either in a test system or in a production system, it is necessary to identify and fix problems with the computer system. Typically, the problems are related to logic errors in the software program, but may also be related to hardware configuration or improper use of the software by a user of the computer system.

When diagnosing a problem in a computer system, a support programmer traditionally turns on a logging utility to collect log entries about the execution of the software program and the data associated with that execution. The logging utility requires a viewer with sorting and/or filtering abilities capable of handling large amounts of information, including a logging facility. The support programmer uses the viewer to sort and/or filter the log entries to examine the log entries related to a particular problem. However, this method is inefficient and sometimes ineffective. Further, some logging utilities generate a volume of data that exceeds the capacity of the viewer or reduces response time performance of production systems to an unacceptable level for users.

Traditionally a logging utility has several preferences that allow the programmer to enable logging for a specific piece of code, subsystem, or the entire system. Although such preferences may be acceptable for diagnosing a problem on a test system, it may cause performance problems, such as decreased response time for users, on a production system. Further, the amount of downloaded log entries can be large and not related to a problem. For example, logged data, which is transmitted to and from servers when executing Hyper Text Transmission Protocol (HTTP) requests, produces a large amount of log entries, some of it in binary format.

Reproducing the problem on a non-production system is a common approach to diagnose an application problem. Once the problem is isolated and reproducible, existing off the shelf Java 2 Platform, Enterprise Edition (J2EE) tools, such as, for example, Log4j, JSR47, and J2EE debuggers, may be used to complete the diagnosis and correction of the problem. J2EE is a programming platform for developing and running distributed multi-tier architecture applications, based largely on modular components running on an application server.

The Log4j system employs different logging hierarchies used when multiple Web applications are running in the same Web container and the applications are the same code, but servicing different customers. A Web container implements a Web component contract of the J2EE architecture. This capability enables logging in a class in one of the web applications, but not the others in the same web container. In the Log4j system, “context” means an application/container context.

Given the scale and complexity of current systems, reproducing a problem outside of the production environment can be costly, inefficient, and ineffective. This is particularly critical for clinical systems, as extended delays in diagnosing and correcting a software defect, may directly affect patient care. Clinical users that lose confidence in the technical staff's ability to find and fix problems may stop using the system to preserve clinical data integrity.

An Application Service Provider (ASP) vendor needs to respond to customer issues with tools that minimize impact on performance and resources. The ASP vendor needs to rapidly find and correct the defect, without interruption or slowdown of the system, especially a production system.

Accordingly, there is a need for an executable application operation monitoring system that addresses these deficiencies and associated problems.

### SUMMARY OF THE INVENTION

A system traces operation of a multi-threaded executable application having concurrently operating code portions. An input processor receives data representing one or more data items being processed by an executable procedure. A filter processor determines whether the received data matches predetermined configuration parameters. A trace processor initiates generation of data tracing execution of instructions, comprising the executable procedure, in response to the received data matching the predetermined configuration parameters. The trace processor inhibits generation of the tracing data in response to the received data failing to match the predetermined configuration parameters.

### BRIEF DESCRIPTION OF THE DRAWINGS

FIG. 1 illustrates an executable application operation monitoring system, in accordance with invention principles.

FIG. 2 illustrates a method for the system, as shown in FIG. 1, in accordance with invention principles.

FIG. 3 illustrates a domain logging architecture, for the system, as shown in FIG. 1, and the method, as shown in FIG. 2, in accordance with invention principles.

FIG. 4 illustrates a graph showing domain versus software package for the domain logging architecture, as shown in FIG. 3, in accordance with invention principles.

### DETAILED DESCRIPTION OF THE PREFERRED EMBODIMENTS

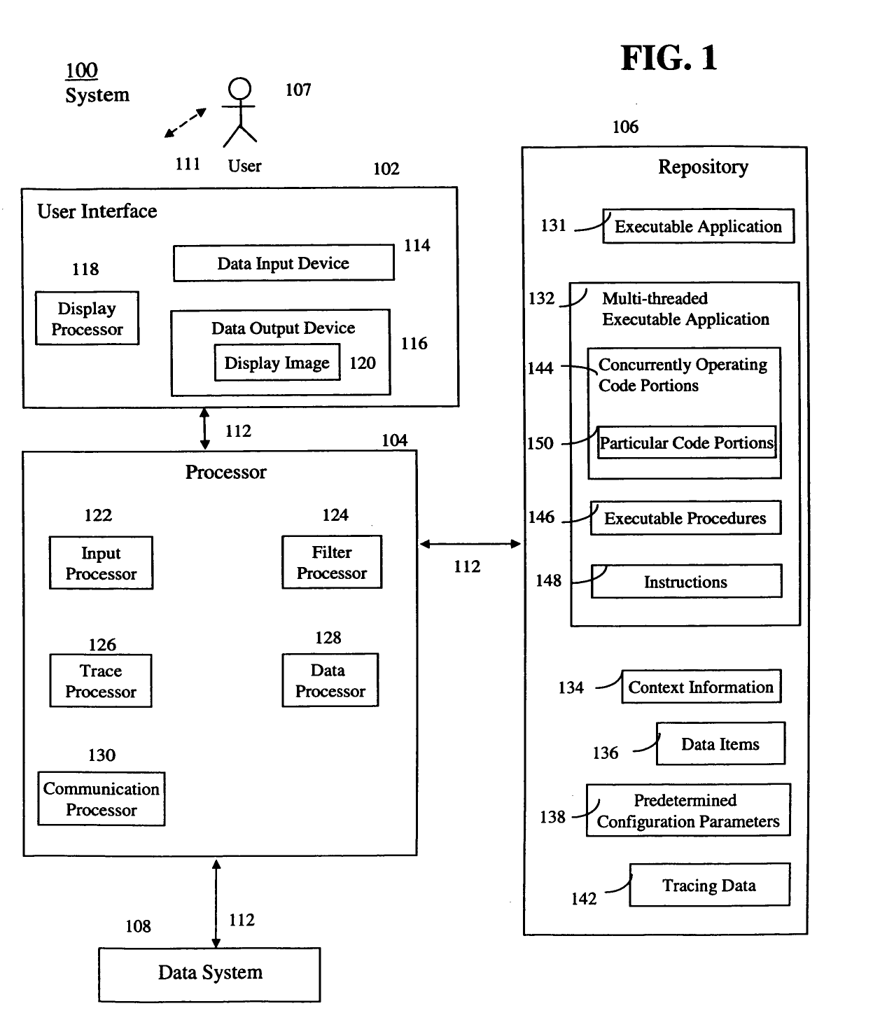

FIG. 1 illustrates an executable application operation monitoring system (i.e., “system”), otherwise called a domain content logging system. The system 100 includes a user interface 102, a processor 104, and a repository 106. A user 107 and a data system 108 interact with the system 100.

A communication path 112 interconnects elements of the system 100, and/or interconnects the system 100 with the data system 108. The dotted line near reference number 111 represents interaction between the user 107 and the user interface 102.

The user interface 102 further provides a data input device 114, a data output device 116, and a display processor 118. The data output device 116 further provides one or more display images 120, which are presented for viewing by the user 107.

The processor 104 further includes an input processor 122, a filter processor (otherwise called a domain filter configuration file) 124, a trace processor (otherwise called logger classifier) 126, a data processor 128, and a communication processor 130.

The repository 106 further includes an executable application 131, a multi-threaded executable application (otherwise called application code) 132, context information 134, data items 136, predetermined configuration parameters (otherwise called domain context keys or domain logging keys) 138, and tracing data (otherwise called a domain log file or domain logger) 142. The multi-threaded executable application 132 further includes concurrently operating code portions 144, executable procedures 146, and instructions 148. The concurrently operating code portions 144 further include a particular code portion 150.

The data system 108 represents a source and/or a destination of any information that may be needed or used by the system 100 including, for example, any of the information stored in the repository 106. The information may be pushed to the system 100 and/or pulled by the system 100, automatically and/or manually, at one time, periodically, or as needed.

The system 100 may be employed by any type of enterprise, organization, or department, such as, for example, providers of healthcare products and/or services responsible for servicing the health and/or welfare of people in its care. For example, the system 100 represents a healthcare information system. A healthcare provider provides services directed to the mental, emotional, or physical well being of a patient. Examples of healthcare providers include a hospital, a nursing home, an assisted living care arrangement, a home health care arrangement, a hospice arrangement, a critical care arrangement, a health care clinic, a physical therapy clinic, a chiropractic clinic, a medical supplier, a pharmacy, a doctor's office, and a dental office. When servicing a person in its care, a healthcare provider diagnoses a condition or disease, and recommends a course of treatment to cure the condition, if such treatment exists, or provides preventative healthcare services. Examples of the people being serviced by a healthcare provider include a patient, a resident, a client, and an individual.

The system 100 may be fixed and/or mobile (i.e., portable). The system 100 may be implemented in a variety of forms including, but not limited to, one or more of the following: a personal computer (PC), a desktop computer, a laptop computer, a workstation, a minicomputer, a mainframe, a supercomputer, a network-based device, a personal digital assistant (PDA), a smart card, a cellular telephone, a pager, and a wristwatch.

The system 100 and/or elements contained therein also may be implemented in a centralized or decentralized configuration. The system 100 may be implemented as a client-server, web-based, or stand-alone configuration. In the case of the client-server or web-based configurations, the executable application 132 may be accessed remotely over a communication network, represented by communication path 112.

The communication path 112 (otherwise called network, bus, link, connection, channel, etc.) represents any type of protocol or data format. The protocol or data format includes, but is not limited to, one or more of the following: an Internet Protocol (IP), a Transmission Control Protocol Internet protocol (TCPIP), a Hyper Text Transmission Protocol (HTTP), an RS232 protocol, an Ethernet protocol, a Medical Interface Bus (MIB) compatible protocol, a Local Area Network (LAN) protocol, a Wide Area Network (WAN) protocol, a Campus Area Network (CAN) protocol, a Metropolitan Area Network (MAN) protocol, a Home Area Network (HAN) protocol, an Institute Of Electrical And Electronic Engineers (IEEE) bus compatible protocol, a Digital and Imaging Communications (DICOM) protocol, and a Health Level Seven (HL7) protocol.

The user interface 102 permits bi-directional exchange of data between the system 100 and the user 107 of the system 100 or another electronic device, such as a computer or an application, for example.

The data input device 114 typically provides data to a processor in response to receiving input data either manually from a user or automatically from another electronic device. For manual input, the data input device is a keyboard and a mouse, but also may be a touch screen, or a microphone and a voice recognition application, for example.

The data output device 116 typically provides data from a processor for use by a user or another electronic device. For output to a user, the data output device 116 is a display, such as, a computer monitor or screen, that generates one or more display images 120 in response to receiving the display signals from the display processor 118, but also may be a speaker or a printer, for example.

The display processor 118 (e.g., a display generator) includes electronic circuitry or software or a combination of both for generating the display images 120 or portions thereof in response to receiving data representing display images, which may be stored in the repository 106. The data output device 116, implemented as a display, is coupled to the display processor 118 and displays the generated display images 120. The display images 120 provide, for example, a graphical user interface, permitting user interaction with the processor 104 or other device. The display processor 118 may be implemented in the user interface 102 and/or the processor 104.

The user interface 102 enables the user 107 to determine one or more of the predetermined configuration parameters 138 by data entry, such as via at least one displayed image 120. The user interface 102 also enables the user 107 to configure a trigger condition causing the particular code portion 150 to provide the input processor 122 with the data, representing the at least one data item 136, being processed by the particular code portion 150.

The system 100, elements, and/or processes contained therein may be implemented in hardware, software, or a combination of both, and may include one or more processors, such as processor 104. A processor is a device and/or set of machine-readable instructions for performing task. The processor includes any combination of hardware, firmware, and/or software. The processor acts upon stored and/or received information by computing, manipulating, analyzing, modifying, converting, or transmitting information for use by an executable application or procedure or an information device, and/or by routing the information to an output device. For example, the processor may use or include the capabilities of a controller or microprocessor.

The input processor 122, the filter processor 124, and the trace processor 126 perform specific functions for the system 100, as explained in further detail herein. The data processor 128 performs other general data processing for the system 100. The communication processor 130 manages communications within the system 100 and outside the system 100, such as, for example, with the data system 108.

The repository 106 represents any type of storage device, such as computer memory devices or other tangible storage medium, for example. The repository 106 may be implemented as a database, for example. The repository 106 represents one or more memory devices, located at one or more locations.

The executable application 131 runs the system 100; whereas, the multi-threaded executable application 132 is diagnosed by the system 100. In other words, the executable application 131 is used to diagnose problems (i.e., bugs) in the executable application 132. Each of the executable application 131 and the multi-threaded executable application 132 generally includes the following features, but are particularly described for the multi-threaded executable application 132.

An executable application comprises machine code or machine readable instruction for implementing predetermined functions including, for example, those of an operating system, a software application program, a healthcare information system, or other information processing system, for example, in response user command or input.

An executable procedure is a segment of code (i.e., machine readable instruction), sub-routine, or other distinct section of code or portion of an executable application for performing one or more particular processes, and may include performing operations on received input parameters (or in response to received input parameters) and providing resulting output parameters.

A calling procedure is a procedure for enabling execution of another procedure in response to a received command or instruction. An object comprises a grouping of data and/or executable instructions or an executable procedure.

A thread is short for a thread of execution or a sequence of instructions. Multiple threads can be executed in parallel on many computer systems. This multi-threading generally occurs by time slicing (e.g., where a single processor switches between different threads) and/or by multiprocessing (e.g., where threads are executed on separate processors). Threads are similar to processes, but differ in the way that they share resources.

The system 100 traces operation of the multi-threaded executable application 132 comprising concurrently operating code portions 144. The input processor 122 receives data, representing one or more data items 136, being processed by the executable procedure(s) 146 or the particular code portion(s) 150 of multiple concurrently operating code portions 144. The filter processor 124 determines whether the received data 136 matches the predetermined configuration parameters 138. The filter processor 124 also determines whether context information 134 of a particular code portion 150 matches the predetermined configuration parameters 138. The trace processor 126 initiates generation of data 142, tracing execution of instructions 148, comprising the executable procedure 146 or the particular code portion(s) 150, respectively, in response to the received data 136 matching the predetermined configuration parameters 138. The trace processor 126 may initiate generation of the tracing data 142 in response to a user selected combination of two or more of the predetermined configuration parameters 138. The trace processor 126 inhibits generation of the tracing data 142 in response to the received data 136 failing to match the predetermined configuration parameters 138.

The predetermined configuration parameters 138 comprise one or more of the following, for example: a customer identifier, a session identifier, a device identifier, a transaction identifier (e.g., HL7 transaction type identifier), a patient identifier (e.g., patent medical record number), and a request identifier (e.g., user name, application, application version, and number).

The context information 134 comprises one or more of the following: a user identifier, an executable application identifier, an executable procedure identifier, and an executable application operating environment identifier.

The particular code portion 150 of the multiple concurrently operating code portions 144 comprises one or more of the following: a portion of an executable application 144, an executable application 132, a sub-routine of an executable application 132, and an individual thread of multiple threads.

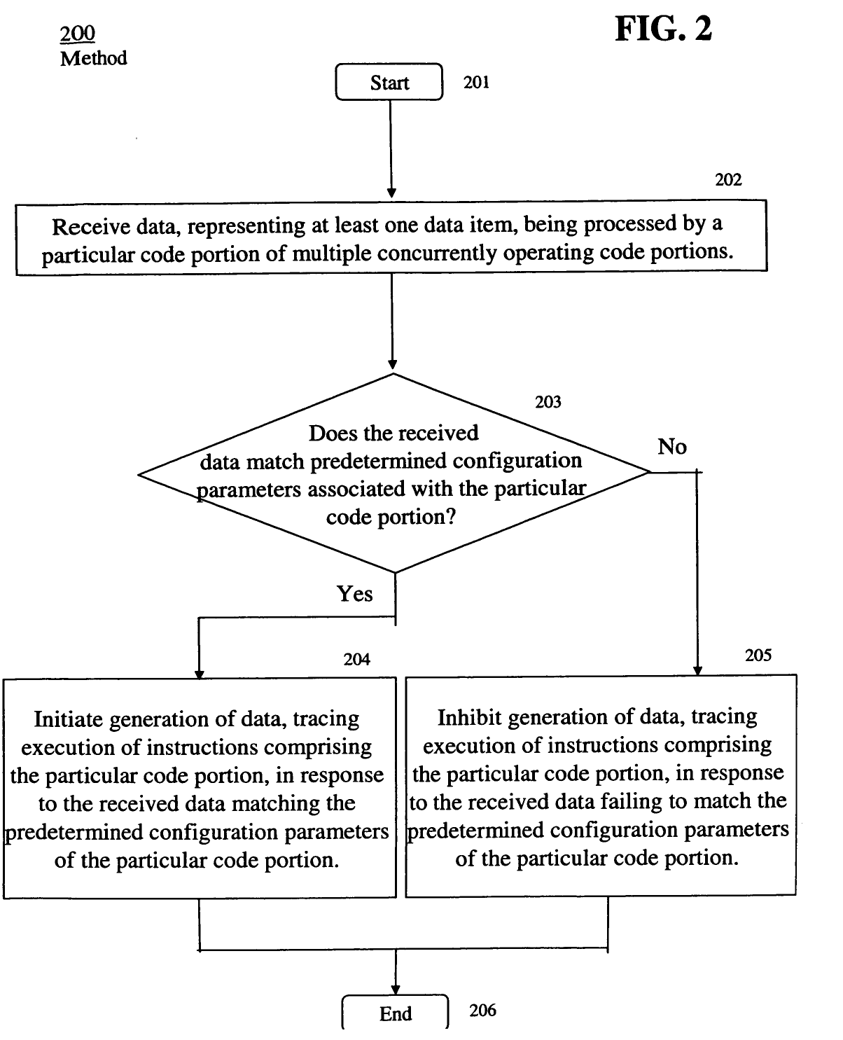

FIG. 2 illustrates a method 200 for the system 100, as shown in FIG. 1. The method 200 performs steps to trace operation of an executable application 132 having concurrently operating code portions 144.

At step 201, the method 200 starts. The system 100 starts step 201 at the appropriate time, after or while performing other processes of the system 100.

At step 202, the method 200 receives data, representing at least one data item 136, being processed by a particular code portion 150 of multiple concurrently operating code portions 144.

At step 203, the method 200 determines whether the received data item 136 matches predetermined configuration parameters 138 associated with the particular code portion 150.

At step 204, the method 200 initiates generation of data 142, tracing execution of instructions 148 comprising the particular code portion 150, in response to the received data 136 matching the predetermined configuration parameters 138 of the particular code portion 150.

At step 205, the method 200 inhibits generation of the tracing data 142 in response to the received data 136 failing to match the predetermined configuration parameters 138 particular code portion 150.

At step 206, the method 200 ends. The system 100 continues to perform other processes of the system 100.

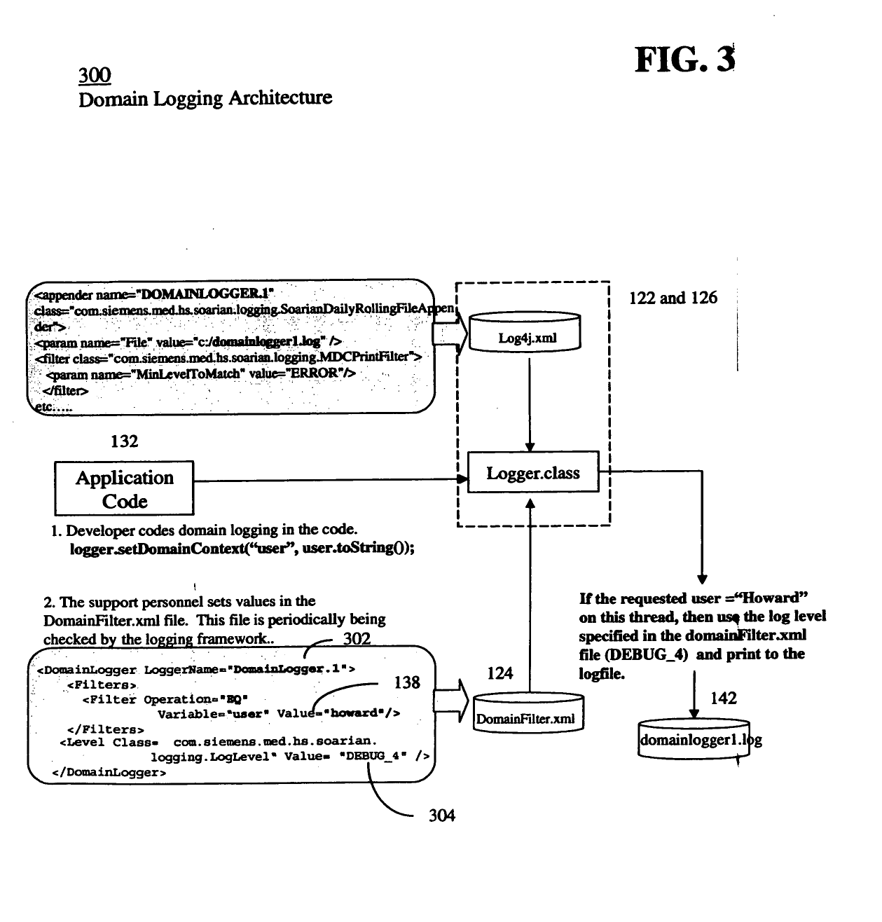

FIG. 3 illustrates a domain logging architecture 300, for the system 100, as shown in FIG. 1, and the method 200, as shown in FIG. 2. The architecture 300 includes the executable application 132, the filter processor 124, input processor 122, the trace processor 126, and the trace data 142.

The executable application 132 is described as the application code. The filter processor 124 is described as the domain filter file. The input processor 122 and the trace processor 126 are described as the domain logger (e.g., Log4j utility) and the Logger.class. The trace data 142 is described as the domain logger log.

The system 100 may employ Service Oriented Architecture (SOA). SOA is a software architectural concept that defines the use of services to support the requirements of software users (e.g., linking resources on demand). In a SOA, resources are made available to other participants in the network as independent services that are accessed in a standardized way. This provides for more flexible loose coupling of resources than in traditional system architectures.

In a large-scale SOA production system where there are many users performing many tasks at the same time it is difficult to diagnose a system problem without affecting system performance or generating large amounts of log data. The system 100 allows technical support personnel to diagnose a problem by enabling logging based on key data associated with the action being performed in the service.

The system 100 may be used in SOA by triggering on the context of the request or data in the request. Because the content of HTTP requests is usually less important for debugging than the HTTP headers, these two types of data are separated into different logs. The content log is “httpclient.wire.content,” and the header log is “httpclient.wire.header,” for example. The system 100 advantageously enables diagnosing a production system, without creating large log files or impacting performance by allowing initiation of logging based on data associated with context, such as by user, transaction ID, session ID, etc.

The system may be employed in other complex environments, such as Application Service Provider (ASP) configurations, where different customers use the same base applications, and applications are tailored to customer specific processing needs. Technical support personnel are able to maintain production goals (e.g., response time, data integrity, fix-repair), without resorting to extraordinary diagnostic techniques, such as cloning production systems into a test system environment. The system 100 may be used for rapid responses to customer support issues, such as when the problem symptoms are difficult to reproduce or are not obvious.

The system 100 supports dynamically changing a logging level for a particular thread, based upon parameters 138 and fields in that thread, such as a Requesting User Name or Customer Identifier, etc. Technical support personnel can isolate a user's activity, without using inefficient prior techniques, such as by adding an entry for the specific users in certain Java classes where the problem may reside in the executable application 132. The system 100 significantly reduces logging records, and makes it easier to diagnose random and/or user specific software problems, such as fatal errors by one user when accessing a particular class of transactions.

By example, a user notifies system support personnel that they have a problem using a production system. Support personnel isolate and tag (i.e., identify) the name of the user in context information 134 (i.e., in a domain context configuration file) for trace logging. When the user reruns the same action that caused the problem, trace statements are executed for the user's work and reported to a log (i.e, trace data 142). The user and/or the support personnel review the log to diagnose the problem that the user is having with the production system. This process occurs, without shutting down the production system and/or without impacting the performance of other users on the production system. This isolation and logging technique improves the diagnosis process, minimizes resource/performance requirements, and facilitates problem identification.

More particularly, the following scenario provides an example of how the system 100 may be used. A technical support call from a hospital indicates that one of their doctors (e.g., Dr. Howard) gets a fatal error system displayed whenever he tries to access patient information. Other doctors do not have the same problem as Dr. Howard. Traditional log files unfortunately provide insufficient information to isolate and debug the problem. Technical support personnel may edit a conventional Log4j.xml file, for example, to add a <logger> entry for the specific loggers (e.g., java classes) where they think the problem is located. However, adding an entry for the specific loggers turns on logging for multiple users of those java classes, and not just for Dr. Howard. Adding an entry for the specific loggers may cause performance problems with the production system, and provide a large amount logging information to be recorded in the log file making it difficult to identify logging information relating just to Dr. Howard.

The system 100 permits the technical support personnel to capture logging information to be recorded in a separate log file whenever the logged in user is Dr. Howard. The system 100 may vary a level of logging information (i.e., a debug log level) to vary the amount of tracing data 142 about the diagnosis. For example, log levels may vary from zero to ten, with log level zero providing little (e.g., high level) information, and with log level ten providing much (e.g., detailed level) information. The log level is increased, for example from say from “DEBUG_0” to “DEBUG_4,” for Dr. Howard's use of the production system, thereby permitting the technical support personnel and/or Dr. Howard to identify and fix the problem.

The following text describes how the system 100 is created and operated.

1. The executable application 132 incorporates context information 134 (i.e., domain logging information or context keys) into appropriate portions of the executable application 132. For example, a developer of the executable application 132 may perform this process. The context information 134 may be represented, for example, generally as DomainLogger.setDomainContext, and, more particularly, as:

DomainLogger.setDomainContext(OperatingContext.REQUESTING_USER_NAME,getSoarianRequestingUserName( ));

DomainLogger.setDomainContext(OperatingContext.REQUESTING_USER_OID,getSoarianRequestingUserOID( ));

DomainLogger.setDomainContext(OperatingContext.REQUESTING_APPLICATION,getSoarianRequestingApplication( ));

DomainLogger.setDomainContext(OperatingContext.REQUESTING_APPLICATION_VERSION,getSoarianRequestingApplicationVersion( ));

DomainLogger.setDomainContext(OperatingContext.REQUEST_NUMBER,String.valueOf(getSoarianRequestNumber( )));

DomainLogger.setDomainContext(OperatingContext.RESPONSIBLE_USER_NAME,getSoarianResponsibleUserName( ));

DomainLogger.setDomainContext(OperatingContext.RESPONSIBLE_USER_OID,getSoarianResponsibleUserOID( ));

DomainLogger.setDomainContext(OperatingContext.ENVIRONMENT,getSoarianEnvironment( ));

DomainLogger.setDomainContext(OperatingContext.CUSTOMER_ID,getSoarianCustomerID( ));

DomainLogger.setDomainContext(OperatingContext.DEVICE_ID,getSoarianDevceID( ));

DomainLogger.setDomainContext(OperatingContext.GSM_SESSION_ID,getSoarianDevceID( ));

DomainLogger.setDomainContext(OperatingContext.PROVIDING_APPLICATION,getSoarianProvidingApplication( ));

2. The predetermined configuration parameters 138 are set for one or more items of the context information 134 so that the filter processor 124 filters the data items 136 received from the executable application 132 in response to the selected predetermined configuration parameters 138. For example, technical support personnel and/or the user may set and/or update the predetermined configuration parameters 138.

The filter processor 124 (e.g., DomainFilter.xml file) filters the information. The trace processor 126 periodically checks the filter processor 124 (e.g., DomainFilter.xml file) to see if the predetermined configuration parameters 138 have changed.

For example, the filter processor 124 determines, if the user on this particular thread has a predetermined configuration parameters 138 equal to “howard,” turn domain logging on at log level=DEBUG_4 304 (see FIG. 3), for example. This has the effect of sending trace data 142 (e.g., log output) to a file (e.g., domainlogger1.log) specified in logger file (e.g., Log4j.xml file) for the information associated with logger “domainlogger1.”

Features of the domain logging include the following, for example.

1. The domain-logger configuration file supports operations “EQ” (equals) and “CONTAINS.” More than one filter may be assigned.

2. The log level for domain logging is controlled by the support programmer, for example, in the domain filter file, but may be overridden by the developer.

3. The entries in a domain filter file are case insensitive. For example, the value “howard” is the same as value “HOWARD.”

The system 100 has multiple advantages in a complex system environment, such as SOA, for example.

1. Performance overhead requirements are minimal when compared to standard logging utilities that depend upon viewers to filter and search data.

2. The key/value pairs controlling the “context” do not have to be specified on each logging call. Rather, they can be established on a thread-by-thread basis, to minimize code impact and limit amounts of non-essential audit information.

3. Logging set up is dynamic within a production system and can be changed without interruption to the running system.

4. The system 100 decreases the time to find a defect by isolating a search to the known parameters associated to the problem being diagnosed, such as, for example, user, application, and patient type, as reported by the user.

5. The system 100 removes the need to have a duplicate set of hardware and software needed to simulate/reproduce a problem experienced in a production for diagnostic purposes.

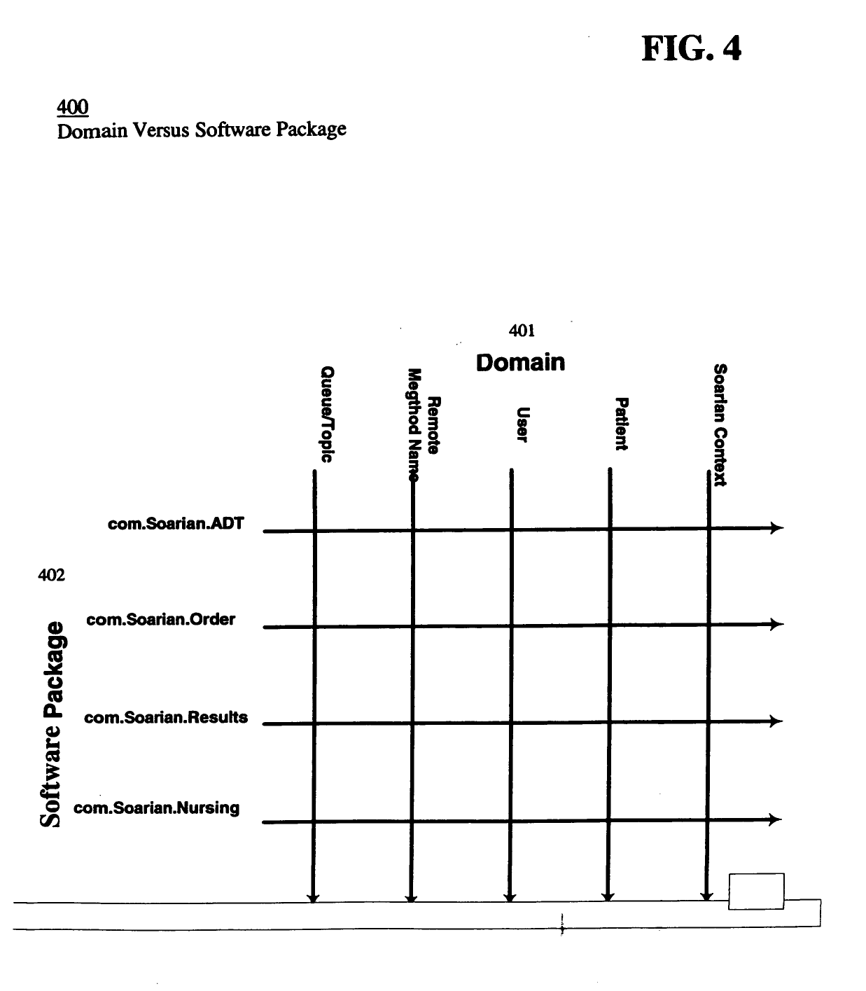

FIG. 4 illustrates a graph 400 showing domain 401 versus software package 402 for the domain logging architecture 300, as shown in FIG. 3. The domain 401 includes, for example, queue/topic, remote method name, user, patient, and context. The software package (e.g., executable application 132 or portion thereof 146, 148, 150) includes, for example, ADT, order, results, and nursing, which represent various parts of a healthcare information system.

The system configures logging based on the context the executable application 132 is running to permit logging based on the data being processed. The system 100 may be coded for portions of the executable application 132 that are of particular interest (e.g., strategic, problematic, etc.). The graph 400 illustrates that one or more domains 401 may correspond or be associated with one or more software packages 402. A support programmer may enable logging for a specific function and a specific user, while ignoring other functions and users, by selecting and setting the predetermined configuration parameters 138 in the filter processor 124. For example, the “user” domain 401 may be configured to correspond to the “results” software package 402. This permits technical support personnel (i.e., a programmer) to diagnose a problem on a production system, without affecting performance. The variable and configurable correspondence between the domain 401 and the software package 402 provides flexibility and focus to efficiently identify and solve problems.

Hence, while the present invention has been described with reference to various illustrative examples thereof, it is not intended that the present invention be limited to these specific examples. Those skilled in the art will recognize that variations, modifications, and combinations of the disclosed subject matter can be made, without departing from the spirit and scope of the present invention, as set forth in the appended claims.

What is claimed is:

1. A system for tracing operation of a multi-threaded executable application comprising concurrently operating code portions, comprising:
an input processor for receiving data representing at least one data item being processed by an executable procedure;
a filter processor for determining whether said received data matches predetermined configuration parameters; and
a trace processor for,
initiating generation of data tracing execution of instructions comprising said executable procedure in response to said received data matching said predetermined configuration parameters and
inhibiting generation of said tracing data in response to said received data failing to match said predetermined configuration parameters.

2. A system for tracing operation of an executable application comprising concurrently operating code portions, comprising:
an input processor for receiving data, representing at least one data item, being processed by a particular code portion of a plurality of concurrently operating code portions;
a filter processor for determining whether said received data match predetermined configuration parameters associated with said particular code portion; and
a trace processor for,
initiating generation of data, tracing execution of instructions comprising said particular code portion, in response to said received data matching said predetermined configuration parameters of said particular code portion and
inhibiting generation of said tracing data in response to said received data failing to match said predetermined configuration parameters of the particular code portion.

3. A system according to claim 2, wherein
said predetermined configuration parameters comprise at least one of, (a) a customer identifier, (b) a session identifier, (c) a device identifier, (d) a transaction identifier, (e) a patient identifier and (f) a request identifier.

4. A system according to claim 2, wherein
said filter processor determines whether context information of a particular code portion matches said predetermined configuration parameters, said context information comprising at least one of, (a) a user identifier, (b) an executable application identifier, (c) an executable procedure identifier and (d) an executable application operating environment identifier.

5. A system according to claim 2, wherein
said input processor receives data representing a plurality of data items being processed by said plurality of concurrently operating code portions;
said filter processor determines whether said received data match the predetermined configuration parameters associated with corresponding particular code portions; and
a trace processor for,
initiating generation of data, tracing execution of instructions comprising at least one particular code portion, in response to said received data matching said predetermined configuration parameters associated with at least one of said corresponding particular code portions, and
inhibiting generation of said tracing data in response to said received data failing to match said predetermined configuration parameters of said corresponding particular code portions.

6. A system according to claim 3, wherein
said trace processor initiates generation of said tracing data in response to a user selected combination of at least two of said predetermined configuration parameters.

7. A system according to claim 2, wherein
said particular code portion of said plurality of concurrently operating code portions comprises at least one of, (a) a portion of an executable application, (b) an executable application and (c) a sub-routine of an executable application.

8. A system according to claim 2, wherein
said particular code portion of said plurality of concurrently operating code portions comprises an individual thread of multiple threads.

9. A system according to claim 2, including
a user interface enabling a user to determine said predetermined configuration parameters by data entry via at least one displayed image.

10. A system according to claim 2, wherein
said particular code portion provides said input processor with said data, representing said at least one data item, being processed by said particular code portion in response to a user configured trigger condition.

11. A system for tracing operation of an executable application comprising concurrently operating code portions, comprising:
an input processor for receiving data representing a plurality of data items being processed by a plurality of concurrently operating code portions;
a filter processor for determining whether said received data matches predetermined configuration parameters associated with corresponding particular code portions, said configuration parameters being independently selectable for different particular code portions; and
a trace processor for,
initiating generation of data tracing execution of instructions comprising at least one particular code portion in response to said received data matching said predetermined configuration parameters associated with at least one of said corresponding particular code portions and
inhibiting generation of said tracing data in response to said received data failing to match said predetermined configuration parameters of said corresponding particular code portions.

12. A method for tracing operation of an executable application comprising concurrently operating code portions, comprising the activities of:
receiving data, representing at least one data item, being processed by a particular code portion of a plurality of concurrently operating code portions;
determining whether said received data match predetermined configuration parameters associated with said particular code portion;
initiating generation of data, tracing execution of instructions comprising said particular code portion, in response to said received data matching said predetermined configuration parameters of said particular code portion; and
inhibiting generation of said tracing data in response to said received data failing to match said predetermined configuration parameters particular code portion.

13. A method according to claim 12, further comprising the activity of:
determining whether said predetermined configuration parameters match context information associated with said particular code portion.

14. A method according to claim 13, wherein the context information comprises at least one of, (a) a user identifier, (b) an executable application identifier, (c) an executable procedure identifier, and (d) an executable application operating environment identifier.

15. A method according to claim 12, wherein
said particular code portion of said plurality of concurrently operating code portions comprises at least one of, (a) a portion of an executable application, (b) an executable application, and (c) a sub-routine of an executable application.

16. A method according to claim 12, wherein
said particular code portion of said plurality of concurrently operating code portions comprises an individual thread of multiple threads.

17. A method according to claim 12, further comprising the activity of:
initiating generation of said tracing data in response to a user selected combination of at least two of said predetermined configuration parameters.

18. A method according to claim 17, further comprising the activity of:
receiving said user-selected combination of at least two of said predetermined configuration parameters by data entry via at least one displayed image.

19. A method according to claim 12, wherein said activity of receiving is in response to a user configured trigger condition.

20. A method according to claim 12, wherein
said predetermined configuration parameters comprise at least one of, (a) a customer identifier, (b) a session identifier, (c) a device identifier, (d) a transaction identifier, (e) a patient identifier and (f) a request identifier.

21. A user interface comprising:
an input device for receiving predetermined configuration parameters,
wherein received data, representing at least one data item being processed by an executable procedure of a multi-threaded executable application having concurrently operating code portions, is compared to the predetermined configuration parameters,
wherein data, tracing execution of instructions comprising the executable procedure, is generated in response to the received data matching the predetermined configuration parameters, and
wherein the tracing data is not generated in response to the received data not matching the predetermined configuration parameters; and
a data output device for providing the generated trace data.
